(19) United States
(12) Patent Application Publication
(10) Pub. No.: US 2022/0309347 A1
(43) Pub. Date: Sep. 29, 2022

(54) END-TO-END ADAPTIVE DEEP LEARNING TRAINING AND INFERENCE METHOD AND TOOL CHAIN TO IMPROVE PERFORMANCE AND SHORTEN DEVELOPMENT CYCLES

(71) Applicant: AONDEVICES, INC., Irvine, CA (US)

(72) Inventors: Mouna Elkhatib, Irvine, CA (US); Adil Benyassine, Irvine, CA (US); Aruna Vittal, Irvine, CA (US); Eli Uc, Irvine, CA (US); Daniel Schoch, Irvine, CA (US)

(21) Appl. No.: 17/703,969

(22) Filed: Mar. 24, 2022

Related U.S. Application Data
(60) Provisional application No. 63/165,309, filed on Mar. 24, 2021.

(51) Int. Cl. G06N 3/08

(52) U.S. Cl. CPC G06N 3/08

(57) ABSTRACT

A deep learning training and inference system for a primary machine learning system has an automated data collection tool receptive to incoming input data from a sensor data source, and embeds one or more sensor data classifications associated with the incoming input data. A data augmentation tool is receptive to the input data from the automated data collection tool and generates an augmented input data set resulting from one or more predefined operations applied to the input data. An adaptive training tool is receptive to the augmented input data set to improve performance, with a new set of weight values being generated for the primary machine learning system. An inference tool is in communication with the adaptive training tool to receive the new set of weight values for an inference model simulator emulating a native hardware environment of the primary machine learning system.

### CROSS-REFERENCE TO RELATED APPLICATIONS

This application relates to and claims the benefit of U.S. Provisional Application No. 63/165,309 filed Mar. 24, 2021 and entitled “An End-To-End Adaptive Learning Training and Inference Method and Tool Chain to Improve Performance and Shorten The Development Cycle Time,” the entire disclosure of which is wholly incorporated by reference herein.

### STATEMENT RE: FEDERALLY SPONSORED RESEARCH/DEVELOPMENT

Not Applicable

### BACKGROUND

### 1. Technical Field

The present disclosure relates generally to machine learning and the training of deep learning systems, and more particularly, to an end-to-end adaptive learning and training inference method and tool chain that improves performance as well as shorten the development cycle time.

### 2. Related Art

Machine learning systems may be employed across a wide range of disciplines and applications involving the use of computers to develop predictive, classification, or decision models, including voice recognition, image recognition, recommendation engines, financial market prediction, medical diagnosis, fraud detection, and so on. In its most basic form, a machine learning algorithm is comprised of a decision process that evaluates input data and makes some manner of prediction, classification, or decision based upon it, along with an error function that evaluates the results of the decision process, and a model optimization process. The machine learning system may be trained through supervised learning, unsupervised learning, semi-supervised learning, reinforcement learning,

In general, training a machine learning system involves providing a set of training data to the algorithm. Varying extents of correlations between input data and the desired output of the algorithm based upon such data may be provided, depending on the supervision level. Generally, generic tools are used to provide a high volume of data collected from different conditions. Current optimization techniques are a highly manual process that lack embedded adaptations to improve performance, and substantially extends the iterative training process. There is little to no standardization of data collection, augmentation, or training processes that improves performance with a short training duration. When developing a customized system for recognizing wake words, commands, sound-based events, and context detection, the lack of such standardization is a significant impediment. Similar concerns also apply to autonomous systems relying on other input data other than audio/speech.

Accordingly, there is a need in the art for an end-to-end adaptive deep learning training and inference method and tool chain, to improve performance and shorten development cycle times.

### BRIEF SUMMARY

The embodiments of the present disclosure are directed to an end-to-end adaptive deep learning training and inference system which improves performance and shortens the duration of development cycles. The standardized tools are understood to achieve a high degree of reproducibility in the training, and standardizes the data capturing and augmentation process as a final neural network model is developed.

According to one embodiment, there may be a deep learning training and inference system for a primary machine learning system. The system may include an automated data collection tool that is receptive to incoming input data from a sensor data source. The automated data collection tool may also embed one or more sensor data classifications associated with the incoming input data. The system may further include a data augmentation tool that is receptive to the input data from the automated data collection tool. The data augmentation tool may generate an augmented input data set resulting from one or more predefined operations applied to the input data. The system may further include an adaptive training tool that is receptive to the augmented input data set to improve performance. A new set of weight values may be generated for the primary machine learning system. The adaptive training tool may be in communication with one or more training tools for the primary machine learning system to provide the augmented input data set thereto. The system may include an inference tool that is in communication with the adaptive training tool to receive the new set of weight values for an inference model simulator emulating a native hardware environment of the primary machine learning system. The inference tool may selectively invoke one or more of the automated data collection tool, the data augmentation tool, and the adaptive training tool for iteratively improving the primary machine learning system.

Another embodiment of the present disclosure may be a method for training a machine learning system. The method may involve collecting incoming input data from one or more sensor data sources, then assigning one or more sensor data classifications to the input data. An augmented input data set may be generated from the input data based upon an application of an augmentation operation of the input data, and a new set of weight values may be generated for a primary machine learning system based upon the augmented input data set. The method may include transmitting the augmented input data set to one or more training tools for the primary machine learning system. There may also be a step of simulating a native hardware environment of the primary machine learning system with the new set of weight values. This method may also be performed with one or more programs of instructions executable by the computing device, with such programs being tangibly embodied in a non-transitory program storage medium.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram of a deep learning training and inference system set up for training a neural network;

FIG. 2 is a diagram illustrating a tool chain of a deep learning training and inference system according to one embodiment of the present disclosure;

FIG. 3 is a diagram showing exemplary sensor data classifications as applied by a data collection tool in the deep learning training and inference system;

FIG. 4 is a diagram showing predefined operations to the input data as applied by a data augmentation tool in the deep learning training and inference system;

FIG. 5 is a process diagram showing the operation of an adaptive training tool in the deep learning training and inference system; and

FIG. 6 is a process diagram showing the operation of an inference tool in the deep learning training and inference system.

### DETAILED DESCRIPTION

The detailed description set forth below in connection with the appended drawings is intended as a description of the several presently contemplated embodiments of a deep learning training and inference system and is not intended to represent the only form in which such embodiments may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

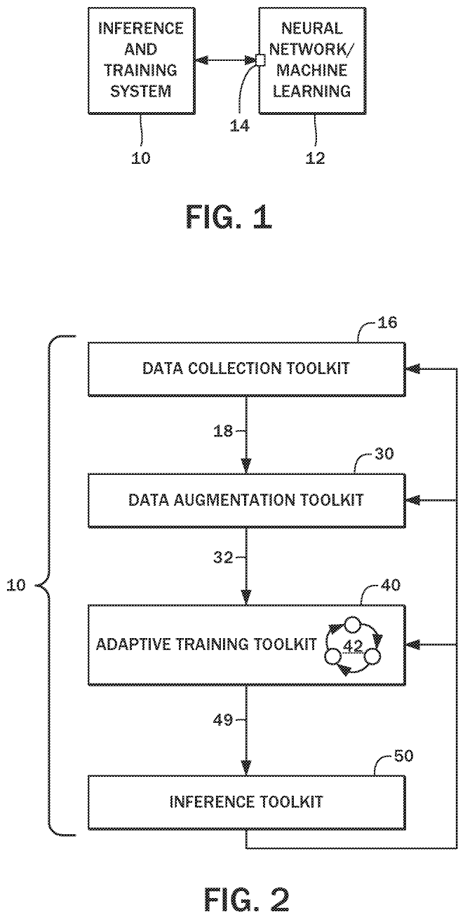

With reference to the diagram of FIG. 1, the embodiments of the present disclosure contemplate a deep learning training and inference system 10 that improves the performance and training of a neural network 12. Conventionally, the neural network 12 may be implemented as a series of instructions executable by a data processor to replicate interconnected neurons that are organized according to an input layer, an output layer, and one or more hidden layers. In this regard, the neural network 12 may have an input 14 which serves as the interface to the deep learning training and inference system 10. It will be recognized that by iteratively training the neural network 12 with input data, the weight values of the various nodes in the hidden layer(s) are adjusted such that a subsequent arbitrary input results in an output decision/classification/identification that is in accordance with the training.

With the neural network 12 being implemented with a computer system, according to some embodiments of the present disclosure, the deep learning training and inference system 10 may likewise be implemented with a computer system as well. The neural network 12 and the deep learning training and inference system 10 may be executing on the same computer system, or on different computer systems that are interconnected with a network link. It will be appreciated that the embodiments of the present disclosure are not dependent on the specifics of such computer system and general hardware environment, so additional details thereof will be omitted.

With reference to the block and flow diagram of FIG. 2, the deep learning training and inference system 10 is comprised of a number of interconnected components, with the training method iteratively stepping through each component, sometimes in sequence, and sometimes out of sequence as will be described more fully below. The component or tool chain is envisioned to improve performance of the overall training process of the neural network 12 and of the neural network 12 itself, as well as shorten development cycles. One component of the deep learning training and inference system 10 may be a data collection toolkit 16, which may be referred to more generally as an automated data collection tool. This component is understood to be receptive to incoming input data from one or more sensor data sources.

As referenced herein, the sensor data source is understood to be any data storage element that includes information from a sensor device, or generated from a simulation of a sensor device. Further, a sensor device may be any device that captures some physical phenomenon and converts the same to an electrical signal that is further processed. For example, the sensor device may be a microphone/acoustic transducer that captures sound waves and converts the same to analog electrical signals. In another example, the sensor device may be an imaging sensor that captures incoming photons of light from the surrounding environment, and converts those photons to electrical signals that are arranged as an image of the environment. Furthermore, the sensor device may be motion sensor such as an accelerometer or a gyroscope that generates acceleration/motion/orientation data based upon physical forces applied to it. The embodiments of the present disclosure and not limited to any particular sensor data source, set of sensor data sources, or any number of sensor data sources, or sensor device type.

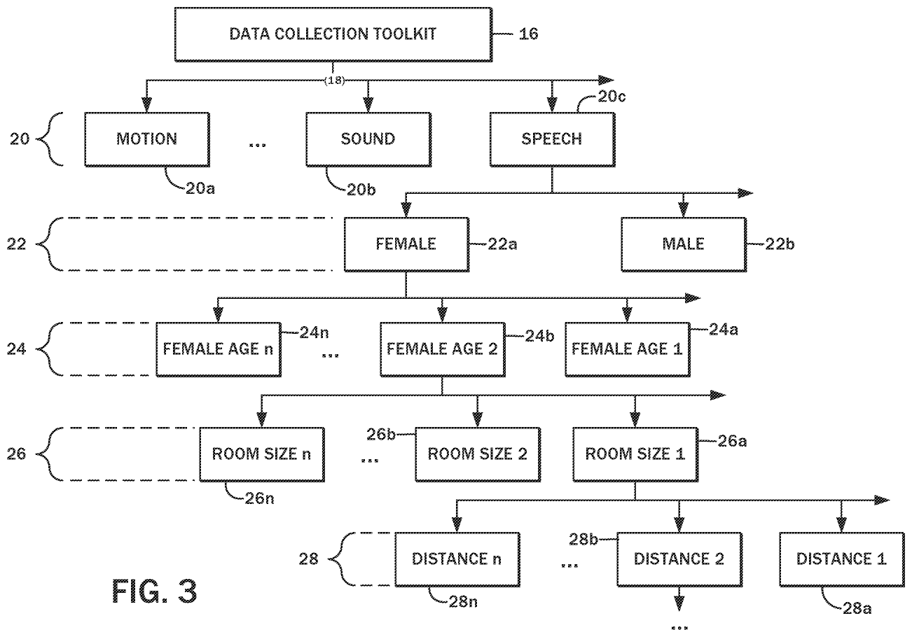

In addition to collecting the input data from the sensor data sources, the data collection toolkit 16 is understood to embedded one or more sensor data classifications/features that are associated with the incoming input data. With reference to FIG. 3, a broad, first level classification 20 of the incoming input data 18 may relate to the type of sensor and/or the type of information represented by the input data 18, such as a motion data classification 20a, a sound classification 20b, and a speech classification 20c. It is expressly contemplated that other types of first level classifications 20 may be assigned to the input data 18. Within the speech classification 20c, the input data 18 may be further classified into a female speech subclass 22a and a male speech subclass 22b, both of which are within a second level classification 22. The input data 18 may be further classified under the female speech subclass 22a as a first female age subclass 24a, a second female speech subclass 24b, and any additional female age subclasses, including an indeterminate female age subclass 24n within a third level classification 24.

From the gender/age subclassifications, the input data 18 may be separately classified into different room sizes from which the audio was captured. For example, there may be a first room size subclass 26a, a second room size subclass 26b, and any additional room size subclasses including an indeterminate room size subclass 26n within a fourth level classification 26. The room size classifications may be further classified as a first distance subclass 28a, a second distance subclass 28b, and any number of additional distance subclasses, including an indeterminate distance subclass 28n. The distance classification, that is, a fifth level classification 28, is understood to specify the distance separating the microphone and the speaker providing the speech for the input data 18.

The foregoing classes and subclasses are presented by way of example only and not of limitation, and the input data 18 may be classified according to any number of additional dimensions. There may be additional classification enumerations at any of the first level classification 20, the second level classification 22, the third level classification 24, the fourth level classification 26, and the fifth level classification 28. There may also be additional levels of classifications not illustrated in the diagram of FIG. 3. Such additional classifications for other types of input data are deemed to be within the purview of those having ordinary skill in the art.

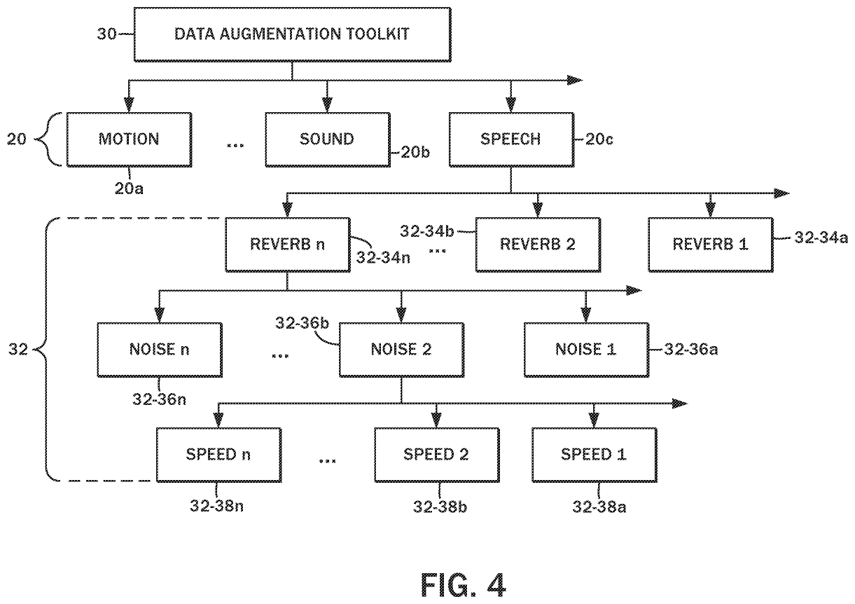

Referring back to the diagram of FIG. 2, the deep learning training and inference system 10 further includes a data augmentation toolkit 30, which is connected to the data collection toolkit 16 discussed above. The data augmentation toolkit 30 receives the input data 18 as collected and classified in the previous step, and expands upon the same by multiple factors (hundreds or thousands). Generally, one or more predefined operations are applied to the input data 18, to result in an augmented input data set 32. Continuing with the example of the audio/speech input data 18 above, and with reference to the diagram of FIG. 4, the expansions or augmentations of the input data 18, that is, the predefined operations applied to the input data 18, are understood to be specific to the broad, first level classification 20.

The example shown expands upon the speech classification 20c, and the augmented input data set 32 is generated from a variety of operations applied to the input data 18. The first operation is the addition of varying levels of reverb 34 applied to speech input data, to result in a first reverb-added data 32-34a, a second reverb-added data 32-34b, and any number of additional reverb-added data, including an indeterminate reverb-added data 32-34n. An exemplary second operation may be the addition of varying levels of noise 36 applied to given ones of the reverb-added data set 32-34, which may yield a first noise and reverb-added data 32-36a, a second noise and reverb-added data 32-36b, and any number of additional data sets of noise and reverb-added data, including an indeterminate noise and reverb-added data 32-36n. The diagram of FIG. 4 further illustrates a third operation of changing speed levels 38 to the noise and reverb added data 32-36, to result in a first speed noise and reverb-added data 32-38a, a second speed noise and reverb-added data 32-38b, and any number of additional data sets of speed-adjusted, noise and reverb-added data including an indeterminate speed adjusted noise and reverb-added data 32-38n.

The audio operations applied to the input data 18 is presented by way of example only, and not of limitation. Any other operation may be applied to the input data 18 specific to the general category to which it has been classified, and similar expansion operations may be performed on motion data, sound data, and so on. Furthermore, the example illustrates the reverb, noise, and speed adjustment permutations of the resultant augmented input data set 32 being generated in hierarchical sequence of such operations. However, this is also exemplary only. For instance, there may be an augmented input data set 32 that is generated solely on different adjusted speeds, without first being modified by added reverb and/or noise.

As shown in the block diagram of FIG. 2, the resultant augmented input data set 32 is provided to an adaptive training toolkit 40, which improves the performance of the neural network 12, generally referred to as a primary machine learning system. A new set of weight values are understood to be generated as a result. Additionally, the learning tools 42 native to the neural network 12 are directly invoked by the adaptive training toolkit 40, also using the received augmented input data set 32.

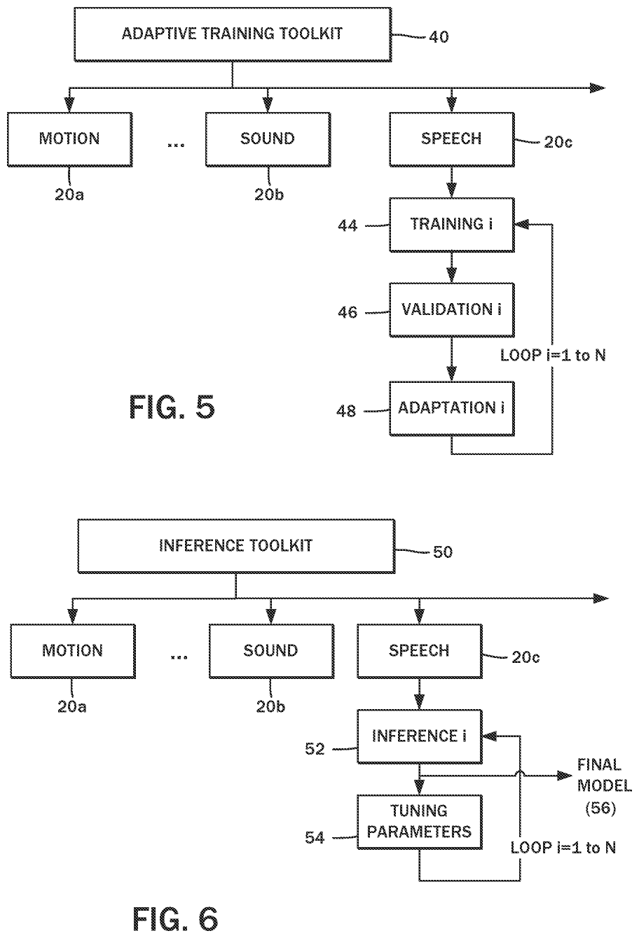

Continuing again with the example of the audio/speech input data 18 above, and with reference to the diagram of FIG. 5, the adaptive training toolkit 40, for each of the first level classifications of the augmented input data set 32 (motion, sound, speech, etc.), performs the training process. In the illustrated example involving the speech classification 20c, the process begins with a training step 44 with a first augmented input data set 32. This training is then validated according to a step 46, and the functioning of the neural network 12 is updated/modified in conformance with the training/validation steps in an adaptation step 48. This training 44-validation 46-adaptation-48 process is repeated for all of the incoming augmented input data sets 32, across all classifications thereof. As a result of this training process, the neural network 12 may generate a new set of weight values 49 based upon the training data it has processed.

Returning to the block diagram of FIG. 2, the deep learning training and inference system 10 further includes an inference toolkit 50 that is in communication with the adaptive training toolkit 40, and receptive to the new set of weight values 49. As shown in the diagram of FIG. 6, for the new set of weight values 49 generated for each of the first level classifications of the augmented input data set 32 (motion, sound, speech, etc.) there is an inference model simulation process 52 that is executed. The inference toolkit 50 is understood to emulate the native hardware environment of the neural network 12/primary machine learning system and may adjust various tuning parameters 54.

Depending on the measured performance, the process may repeated back from the data collection toolkit 16, the data augmentation toolkit 30, or the adaptive training toolkit 40. To the extent the valuation determines that additional input data is necessary, the execution of the deep learning training and inference system 10 may return to the data collection toolkit 16. Where the evaluation determines that data augmentation is needed to account for further possible variations, the data augmentation toolkit 30 may be invoked. If an update to the hyperparameters governing the overall operation of the deep learning training and inference system 10, or if additional training cycles executed by the local neural network training tools is deemed necessary, then the adaptive training toolkit 40 may be invoked. Once the performance of the neural network 12 has been improved to such a level for deployment in an end device, a final model 56 is generated.

According to various embodiments of the deep learning training and inference system 10, a standardization of the data capture process, we well as software libraries and processes used in the augmentation and training of the final model 56 is contemplated. Optimal performance of the neural network 12, and the training process thereof, is understood to be reliant on the careful selection of these details, and so the standardization is an important objective. The processes utilized by the deep learning training and inference system 10 are contemplated to expedite various iterative processes. The need for the user to analyze the impact of the quality and/or quantity of the final data can be eliminated, as the data augmentation toolkit 30 provides robustness to the input data that is fed to the training tools of the neural network 12. Hyperparameter tuning and reinitialized trainings can be minimized because of the high reproducibility of the aforementioned tools in the deep learning training and inference system 10.

The particulars shown herein are by way of example and for purposes of illustrative discussion of the embodiments of a deep learning training and inference system and method, and are presented in the cause of providing what is believed to be the most useful and readily understood description of the principles and conceptual aspects. In this regard, no attempt is made to show details with more particularity than is necessary, the description taken with the drawings making apparent to those skilled in the art how the several forms of the present disclosure may be embodied in practice.

What is claimed is:

1. A deep learning training and inference system for a primary machine learning system, comprising:
an automated data collection tool receptive to incoming input data from a sensor data source and embeds one or more sensor data classifications associated with the incoming input data;
a data augmentation tool receptive to the input data from the automated data collection tool to generate an augmented input data set resulting from one or more predefined operations applied to the input data;
an adaptive training tool receptive to the augmented input data set to improve performance with a new set of weight values being generated for the primary machine learning system, the adaptive training tool being in communication with one or more training tools for the primary machine learning system to provide the augmented input data set thereto; and
an inference tool in communication with the adaptive training tool to receive the new set of weight values for an inference model simulator emulating a native hardware environment of the primary machine learning system, the inference tool selectively invoking one or more of the automated data collection tool, the data augmentation tool, and the adaptive training tool for iteratively improving the primary machine learning system.

2. The deep learning training and inference system of claim 1, wherein the sensor data source is connected to a microphone and the incoming input data is an audio data stream.

3. The deep learning training and inference system of claim 2, wherein the one or more sensor data classifications is selected from a group consisting of: distance to microphone, room size, speaker age, and speaker gender.

4. The deep learning training and inference system of claim 2, wherein the augmented input data set is generated from the input data by applying an audio process thereto, the audio process being selected from a group consisting of: addition of noise, addition of reverberation, speed increase, and speed decrease.

5. The deep learning training and inference system of claim 1, wherein the one or more training tools for the primary machine learning system are specific to a training category, each of the one or more training tools independently iterating through a training, validation, and adaptation loop for a given one of the training categories.

6. The deep learning training and inference system of claim 1, wherein the inference tool generates a set of hyperparameter updates to the adaptive training tool, the set of hyperparameters governing the function of the adaptive training tool.

7. A method for training a machine learning system, comprising:
collecting incoming input data from one or more sensors data sources;
assigning one or more sensor data classifications to the input data;
generating an augmented input data set from the input data based upon an application of an augmentation operation of the input data;
generating a new set of weight values for a primary machine learning system based upon the augmented input data set;
transmitting the augmented input data set to one or more training tools for the primary machine learning system; and
simulating a native hardware environment of the primary machine learning system with the new set of weight values.

8. The method of claim 7, further comprising:
collecting additional incoming input data from the one or more sensor data sources in a subsequent training iteration improving the primary machine learning system.

9. The method of claim 7, further comprising:
generating an additional augment input data set in a subsequent training iteration improving the primary machine learning system.

10. The method of claim 7, further comprising:
generating an additional new set of weight values for the primary machine learning system in a subsequent training iteration improving the primary machine learning system.

11. The method of claim 10, further comprising:
simulating the native hardware environment of the primary machine learning system with the additional new set of weight values for the primary machine learning system in the subsequent training iteration.

12. The method of claim 7, wherein one of the sensor data sources is connected to a microphone and the incoming input data is an audio data stream.

13. The method of claim 12, wherein the one or more sensor data classifications is selected from a group consisting of: distance to microphone, room size, speaker age, and speaker gender.

14. The method of claim 12, wherein the augmentation operation is applying an audio process to the input data, the audio process being selected from a group consisting of: addition of noise, addition of reverberation, speed increase, and speed decrease.

15. The method of claim 7, wherein the one or more training tools receptive to the augmented input data set are specific to a training category, each of the one or more training tools independently iterating through a training, validation, and adaptation loop for a given one of the training categories upon receipt of the augmented input data set.

16. The method of claim 7, further comprising:
generating a set of hyperparameter updates to the adaptive training tool, the set of hyperparameters governing the function of the adaptive training tool.

17. An article of manufacture comprising a non-transitory program storage medium readable by a computing device, the medium tangibly embodying one or more programs of instructions executable by the computing device to perform a method for training a machine learning system, the method comprising:
collecting incoming input data from one or more sensor data sources;
assigning one or more sensor data classifications to the input data;
generated an augmented input data set from the input data based upon an application of an augmentation operation of the input data;
generating a new set of weight values for a primary machine learning system based upon the augmented input data set;
transmitting the augmented input data set to one or more training tools for the primary machine learning system; and
simulating a native hardware environment of the primary machine learning system with the new set of weight values.

18. The article of manufacture of claim 17, wherein the method further includes:
collecting additional incoming input data from the one or more sensor data sources in a subsequent training iteration improving the primary machine learning system.

19. The article of manufacture of claim 17, wherein the method further includes:
generating an additional augment input data set in a subsequent training iteration improving the primary machine learning system.

20. The article of manufacture of claim 17, wherein the method further includes:
generating an additional new set of weight values for the primary machine learning system in a subsequent training iteration improving the primary machine learning system.
